(19) United States
(12) Patent Application Publication
(10) Pub. No.: US 2023/0213077 A1
(43) Pub. Date: Jul. 6, 2023

(54) BRAKE ASSEMBLY AND METHOD FOR OPERATING A BRAKE ASSEMBLY FOR A VEHICLE WHEEL

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/091,696

(22) Filed: Dec. 30, 2022

(30) Foreign Application Priority Data
Dec. 30, 2021 (DE) 102021215118.3

(51) Int. Cl. F16D 65/22; F16D 65/12; F16D 55/04

(52) U.S. Cl. CPC F16D 65/22; F16D 65/12; F16D 55/04; F16D 2121/18

(57) ABSTRACT

A brake assembly includes a braked member that is coupable or coupled to the vehicle wheel for a joint rotation therewith about a rotational axis, the braked member having contact surfaces that are arranged at an axial distance from one another and a braking unit that comprises a brake force generator and at least two brake pads, the brake pads being positioned in between the contact surfaces, wherein the brake force generator is configured move the brake pads axially apart from one another, thereby bringing each brake pad into contact with one of the contact surfaces of the braked member.

### CROSS-REFERENCE TO RELATED APPLICATION

This application is based on and claims priority under 35 U.S.C. § 119 to German Patent Application No. 102021215118.3 filed on Dec. 30, 2021 in the German Patent and Trade Mark Office, the disclosures of which are incorporated herein by reference.

### TECHNICAL FIELD

The invention relates to a brake assembly and to a method for operating a brake assembly. The brake assembly acts on a vehicle wheel, e.g. of a road vehicle, such as a car or a truck.

### BACKGROUND

It is known to provide brakes for vehicle wheels and in particular for individually braking a vehicle wheel. Typically, disc brakes or drum brakes are used. In case of disc brakes, brake pads are arranged at different sides of a brake disc and are axially moved towards one another to clamp the brake disc in between them. In case of drum brakes, brake pads are radially moved to contact a rotating brake drum.

While both of these established designs have distinct advantages, there still remains room for improvement. For example, the generation of brake noises and the emission of brake dust remains an issue.

### SUMMARY

The object of the present invention is to provide a brake assembly that limits at least some of the disadvantages of existing brake assemblies.

This object is solved by the subject matter of the attached independent claims. Advantageous embodiments are defined in the dependent claims and in this description.

Accordingly, a brake assembly for a vehicle wheel is disclosed, the brake assembly comprising:
a braked member that is coupable or coupled to the vehicle wheel for a joint rotation therewith about a rotational axis, the braked member having (e.g. inner) contact surfaces that are arranged at an axial distance from one another; and
a braking unit that comprises a brake force generator and at least two brake pads, the brake pads being (e.g. axially) positioned in between the contact surfaces,
   wherein the brake force generator is configured to move the brake pads axially apart from one another, thereby bringing each brake pad into contact with one of the contact surfaces of the braked member.

Terms such as axial, radial and circumferential may generally refer to the rotational axis. A radial direction may extend at an angle and in particular orthogonally to the rotational axis, whereas a circumferential direction may extend about or around the rotational axis.

With the above configuration, an arrangement of the braked member similar to existing disc brake designs may be provided. That is, the braked member may extend at an angle and in particular orthogonally to the rotational axis and the brake pads are preferably axially movable as well. This is different from typical drum brake designs in which the brake pads are moved radially.

Yet, in the present case the brake pads are preferably axially positioned in between the contact surfaces, e.g. instead of the contact surfaces (such as in existing disc brakes) being positioned in between the brake pads. Further, during braking the brake pads are axially moved apart from one another or, put differently, are axially spread. In consequence, they can be brought into contact with a respectively adjacent or opposite contact surface, thereby generating frictional forces providing a braking effect. This can also be referred to as the braking unit tightening or tensioning within the braked member by pushing its brake pads outwards against the contact surfaces.

The contact surfaces may be planar and/or smooth surfaces. They may comprise or be made from a metallic material.

In one example, the contact surfaces are formed by brake disc portions and/or disc-like members. For example, each brake disc portion may provide one of the contact surfaces. Accordingly, the braked member may comprise two brake disc portions that are axially spaced apart from one another. In the (axial) space between said brake disc portions, the brake pads may be received. In this case, the contact surfaces may be formed by the faces of the brake disc portions that face one another. The braked member may comprise a connecting portion connecting the brake disc portions, such as an axially extending hub portion.

Alternatively, the braked member can be considered to represent one large disc member e.g. having a circumferential and/or or ring-shaped circumferential recess or slot in which the brake pads are positioned. In this case, the contact surfaces may form inner or internal surfaces of said large slotted disc member.

The suggested brake assembly is advantageous in that new design parameters are available that can be optimised for avoiding existing disadvantages. For example, the braked member may be dimensioned differently from existing single brake discs and may in particular be at least somewhat axially wider and/or more rigid. This may be advantageous in terms of reducing vibrations and/or noises during braking. Also, this helps to avoid Eigenfrequencies in frequency ranges that have been found to be critical for brake noise generation, such as a frequency range from 1000 Hz to 6000 Hz.

Further, with the suggested design, components of the brake assembly, such as the brake force generator and brake pads, can be at least partially shielded from the environment due to being accommodated within the braked member (e.g. within the ring-shaped recess discussed above). This provides protection, e.g. from humidity, dirt or weather conditions, and can thus help to improve longevity of the brake assembly. Further, it can help to reduce emissions of brake dust into the environment and/or may provide a noise shielding effect.

The brake pads may have a brake lining comprising a friction material. The friction material may comprise, for example, friction fibers or friction particles (e.g. metallic particles) and a binder. Accordingly, the friction material may be or comprise a material composition with particles and/or fibers distributed in a (rigid) binder material. In a generally known manner, the brake pads may experience wear and in particular stronger wear than the contact surfaces.

Generally, the material of the contact surfaces may differ from the material of the brake pads. Preferably, the contact surfaces comprise a material that is harder than a material of the brake pads. This reduces wear of the contact surfaces compared to both brake pads. Additionally or alternatively, a friction coefficient of the contact surfaces may be smaller than that of the brake pads.

The brake force generator may operate e.g. hydraulically or electrically. The brake force generator may be configured to, e.g. by activating one single actuator, simultaneously displace the brake pads towards a respectively opposite contact surface. In one example, the brake force generator comprises a hydraulic chamber and both the brake pads are displaceable when generating pressure in said hydraulic chamber. For example, each brake pad can be coupled to a respectively associated piston, said piston being hydraulically coupled to and/or received in the hydraulic chamber. For example, the pistons may be arranged at and/or coupled to opposite sides of the hydraulic chamber. They may axially be pushed out of and/or away from a center of the hydraulic chamber when a brake pressure is built up therein.

The brake force generator may be, may represent or may comprise a brake caliper. In particular, the brake caliper may be a fixed caliper with e.g. only the pistons attached to each brake pad moving relative to a caliper housing. Contrary to existing disc brake caliper designs, in the present case the brake caliper may move the brake pads axially apart from one another, e.g. due to being positioned in between them and pushing its pistons axially outward during a brake activation.

Each brake pad may face a respectively adjacent or opposite contact surface. On the other hand, the brake pads (in particular their brake linings and/or friction material) may face away from one another. The brake pads are preferably arranged on opposite sides of the brake force generator and/or caliper and/or housing. When being moved apart from one another, an axial distance between the brake pads may increase. An axial distance between each brake pad and a respectively opposite contact surface may be reduced to zero, so that a contact is established.

When viewed in an axial direction, the brake pads can be accommodated within a space (e.g. formed by the circumferential slot or recess discussed above), the space being (axially) confined by the contact surfaces. Put differently, at least part of the brake pads can be arranged or be received inside the braked member.

The brake assembly preferably forms part of a vehicle wheel brake for braking individual wheel of the vehicle. Accordingly, the braked member may be connected to a wheel hub or axle component that is connected to said specific wheel. In one aspect, the brake assembly is not part of a vehicle axle brake and/or does not act on a vehicle axle to which a plurality of wheels is connected, e.g. a left and a right wheel. Generally, the brake assembly is optionally arranged at and/or adjacent to the wheel that it is supposed to brake.

According to a preferred embodiment, the contact surfaces face each other. In other words, they may be positioned axially opposite to one another.

For example, the contact surfaces may form at least part of opposite side faces, the side faces belonging to and/or confining a space (or recess or slot) in which the brake pads are at least partially received.

Accordingly, the braked member may generally provide a space for receiving the brake pads. This space may e.g. be a ring-shaped recess or circumferential slot as noted above. It may be opened at an radially outer or upper side. In the axial direction, it may be confined by the contact surfaces. In the circumferential direction, it may be continuous and/or non-obstructed (i.e. ring shaped). A radially inner or lower side (or bottom face) may be confined by a connection portion of the braked member.

The space may have a radial depth or a radial extension that is larger than a radial extension of the brake pads. This way, the brake pads can be fully arranged within and/or may be sunken into this space. Similarly, at least part of the brake force generator (in particular a possible brake caliper thereof) may be received within the space.

An axial width of the space may be dimensioned so that a gap can be provided between each brake pad and a respectively opposite contact surface when the brake is inactive. This helps to reduce drag torque caused by a maintained contact between the brake pads and contact surfaces even though the brake is not activated.

According to a preferred embodiment, a brake dust collector is arranged within the space, in particular at a bottom face that extends in between the contact surfaces. The brake dust collector may e.g. be formed as a ring-shaped lining or ring-shaped member. It may comprise an adhesive, so that the brake dust may adhere thereto. The brake dust collector may be exchanged during maintenance, once it has collected a large amount of brake dust. This way, it can be disposed of appropriately without the brake dust being randomly and continuously emitted into the environment when operating the vehicle.

In one aspect, the brake pads are axially movable apart from one another. This may include the brake pads being movable along an axis that extends in parallel to the rotational axis. Generally, the movement of the brake pads may be linear, e.g. by being pushed towards the contact surfaces in a straight movement.

Yet, axially moving the brake pads apart is not to be understood limiting with respect to the type of movement. For example, a rotational or tilted movement or a each brake pad moving along an individual movement axis may be implemented. This may equally result in an axial distance between the brake pads increasing when braking.

In one example, the brake pads are tilted with respect to one another and/or are each movable along a movement axis, the movement axes of the brake pads being tilted relative to one another. For example, the movement axes may together define a V-shape. Accordingly, the brake pads may be moved axially apart from one another while altering a distance to the rotational axis. For example, said distance may be lowered of increased. The brakes pads may thus be axially pushed apart while being radially lowered or raised accordingly. The contact surfaces may be oriented and in particular tilted similar, e.g. so as to extend in parallel to front faces of the brake pads and in particular to their brake linings. For example, the contact surfaces may be tilted inwardly and/or towards their respective opposite contact surface, which may limit bending.

This way, contact forces may be exerted by the brake pads not only in an axial direction, but at least partially also at an angle to the rotational axis. This may be beneficial form a constructional point of view, e.g. in terms of stress distribution.

According to preferred embodiment, the contact surfaces are each comprised by brake disc portions (e.g. provided in form of distinct brake discs) of the braked member. For example, a first brake disc portion may comprise a first contact surface and a second brake disc portion may comprise a second contact surface—The first and second contact surface may face one another.

At the respective other surface of each brake disc portion that faces axially outward, no brake forces may be generated. That is the internally arranged brake pads may be the only brake pads acting on a respective contact surface. Yet, according to other embodiments, additional brake pads may be provided which act on said axially outward surface of at least one of the brake disc portions as well.

The brake disc portions may be configured according to known examples. Yet, they may deviate from existing designs with respect to their fixation within brake assembly and e.g. to a connection portion of the braked member that axially extends in between the brake disc portions. For example, the connection portion carries the brake disc portions and/or connects them to one another. Generally, the braked member may be a multi-part member but can also be a one-piece member. The braked member (or at least its brake disc portions and/or connecting portion) can be rotation symmetric with respect to the rotational axis.

It is generally possible that the brake disc portions extend in parallel to one another. In particular, the brake disc portions may each extend orthogonally to the rotational axis of the braked member.

In one example, at least one of the brake disc portions comprises a stiffening structure. The stiffening structure, which may e.g. be a preferably massive section of material, may be positioned on a side of the brake disc portion that is opposite to the side comprising the contact surface. This side may face away from the brake pads. It may be an axially outer side. The stiffening structure may e.g. be a rib, a pillar or a web. It may connect the brake disc portions to another section of the braked member, e.g. to the connection portion. Generally, the stiffening structure may support the brake disc portions against extensive bending or defection during braking.

The brake pads can be movable relative to one another, preferably with both brake pads being actively moved during braking. According to one example, each of the brake pads is displaceable relative to a housing of the braking unit.

The housing of the braking unit may be or may be comprised by a brake caliper. It may contain a hydraulic chamber and/or an electric actuator that are configured to generate forces for moving the brake pads. The braking unit housing may be received in the same space (e.g. the slot or recess) of the braked member as the brake pads. The braking unit housing may be fixed in position, even during braking. Yet, especially when also comprising further brake pads acting on axially outer contact surfaces as discussed below, the braking unit housing may comprise or be connected to other movable parts apart from the (inner) brake pads, for example in order to provide a swimming saddle function.

According to preferred example, the brake force generator comprises an electric actuator or hydraulic chamber. By means of each of the actuator and hydraulic chamber, the force for moving both of the brake pads can be generated. The actuator may in particular comprise an electric motor and/or a gear stage. The actuator or hydraulic chamber may be the single source for generating the respective force for moving both brake pads or any brake pads in case a respective larger number of brake pads is provided.

The actuator or hydraulic chamber may at least partially be arranged (axially) between the brake pads and/or within the space of the braked member receiving the brake pads. Accordingly, in a further embodiment at least part of the actuator or hydraulic chamber are received in said space.

According to a further embodiment, at least one further brake pad is provided that can be brought into contact with a further (e.g. outer) contact surface facing away from at least one of the other (e.g. inner) contact surfaces. This further contact surface may be an axially outer surface of the braked member. It may not confine the space receiving the inner brake pads that are moved apart. It may be provided on a rear side or outer side of a brake disc portion whose other contact surface confines said inner space.

In one example, the braked member has two inner contact surfaces and two outer contact surfaces. The inner contact surfaces may be the contact surfaces discussed above that confine a space for receiving the brake pads. The outer contact surfaces may be configured similar to the further contact surface discussed above. The may face outwards. Brake pads may be provided to contact each of the contact surfaces, so that there may be at least four brake pads overall. The brake pads contacting the outer surfaces may be axially movable and may in particular move axially inward. They may represent outer brake pads whereas the brake pads that are moved apart for contacting the inner contact surfaces may be referred to as inner brake pads.

Preferably, each of the at least four brake pads is movable by means of the same brake force generator. For example, the may each be connected to a common actuator or a common hydraulic chamber. In one example, a caliper is provided comprising a hydraulic chamber that is coupled to pistons connected to each of the brakes pads. The caliper or a general housing of the braking unit may extend into the space receiving the inner brake pads. It may also extend so as to have at least one portion opposite to and/or facing one of the outer contact surfaces. Preferably, there are two such portions overall facing both outer contact surfaces.

In any of the embodiments having four braking pads, two pairs of braking pads may be formed, each pair clamping one of the brake disc portions in between them. Still, however, this includes that the braking pads contacting the inner contact surfaces axially move apart from one another.

The invention also concerns a method of operating a brake pad assembly, the brake pad assembly comprising:
a braked member that is coupable or coupled to the vehicle wheel for a joint rotation therewith about a rotational axis, the braked member having contact surfaces that are arranged at an axial distance from one another; and
a braking unit that comprises at least two brake pads, the brake pads being positioned in between the contact surfaces,
   wherein the method comprises: moving the brake pads axially apart from one another, thereby bringing each brake pad into contact with one of the contact surfaces of the braked member.

The method may comprise any further steps or measures to provide any operations and effects disclosed herein in connection with the brake assembly. Any disclosure in connection with the features of the brake assembly, such as possible variants thereof, equally applies to the similar features of the method.

Embodiments of the invention are described below with respect to the attached schematic figures. Similar features may be marked with same reference signs throughout the figures.

### BRIEF DESCRIPTION OF DRAWINGS

FIG. 1 is a cross-sectional view of a brake disc assembly according to a first embodiment of the invention.

FIG. 2 is a cross-sectional view of a brake disc assembly according to a second embodiment of the invention.

FIG. 3 is a cross-sectional view of a brake disc assembly according to a third embodiment of the invention.

FIG. 4 is a cross-sectional view of a brake disc assembly according to a fourth embodiment of the invention.

### DETAILED DESCRIPTION

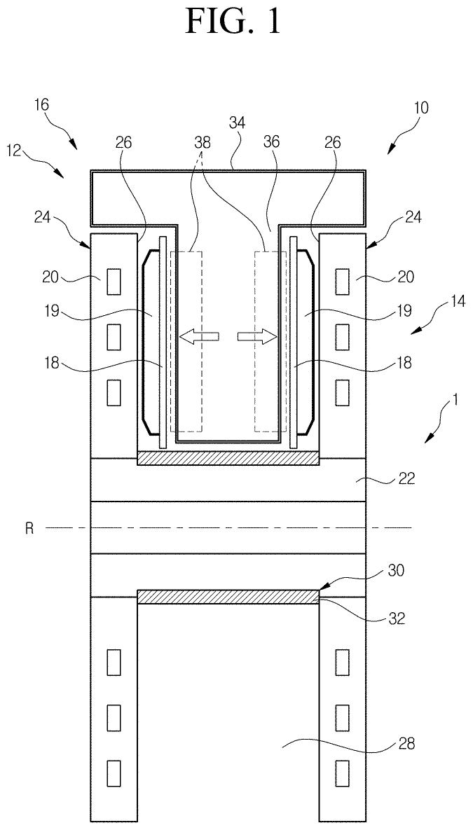

In FIG. 1, a cross-sectional view of a brake assembly 10 according to an embodiment of the invention is shown. The brake assembly 10 is provided for braking a vehicle wheel whose position is indicated by reference sign 1. Accordingly, the vehicle wheel is positioned axially next to the brake assembly 10. The vehicle wheel rotates about an axis R. The cross-sectional plane of FIG. 1 extends vertically and includes the rotational axis R.

The brake assembly 10 comprises a braked member 14 that jointly rotates with the vehicle wheel about the rotational axis R. The connection between the braked member 14 and the vehicle wheel may be formed according to configurations of known disc brakes, e.g. by connecting both to a wheel hub and/or to a common axle component.

The brake assembly 10 also comprises a braking unit 16. The braking unit 16 has two brake pads 18 that are displaceable to contact the braked member 14, thereby slowing down or stopping its rotation. The braking unit 16 also has a hydraulic brake force generator 12.

The braked member 14 has two brake disc portions 20. In the shown example, these are provided and comprised by distinct brake disc members. The brake disc members are fixed to an axially extending connecting portion 22. Merely as an example, the connecting portion 22 is hollow and preferably has a tube-like hollow configuration to e.g. receive an axle component therein.

The brake disc portions 20 each extend orthogonally and concentrically to the rotational axis R. They have a round shape and may generally be configured similar to known brake disc, e.g. in terms of material and structure.

Each brake disc portion 20 has an axially outer contact surface 24 and an axially inner contact surface 26. The contact surfaces 24, 26 are each smooth and preferably metallic surfaces. The inner contact surfaces 26 of the brake disc portions 20 face inwards and face one another. The other contact surfaces 24 face outwards and away from the respective inner contact surface 26 of each brake disc portion 20.

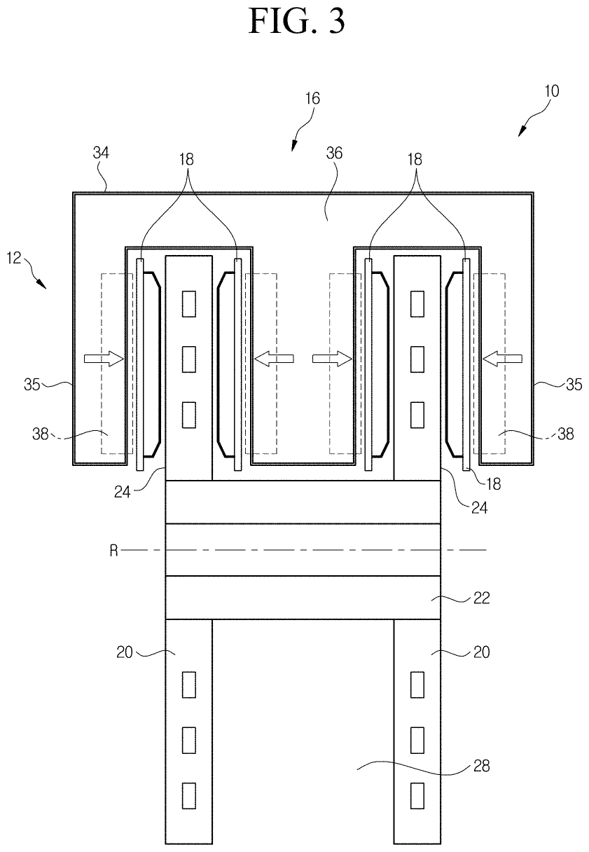

In the example of FIG. 1, the outer contact surfaces 24 are not used for generating braking forces, i.e. are not contacted by any brake pad 18. An embodiment where the outer contact surfaces 24 are also used for generating great forces is described below with respect to FIG. 3.

The inner contact surfaces 26 confine a space 28 in between them. Said space 28 forms a circumferentially extending slot or ring within the braked member 14. Its axial side faces are formed by the inner contact surfaces 26. A bottom face 30 of the space 28 is provided by the connecting portion 22. In the shown example, a brake dust collector 32 is arranged at and/or forms at least a section of the bottom face 30. The brake dust collector 32 is a ring-shaped member or layer that is arranged at an outer circumferential surface of the connecting portion 22. It comprises an adhesive to which brake dust sticks instead of being emitted into the environment.

The braking unit 16 at least partially extends into the space 28. In particular, its brake pads 18 are preferably fully received within the space 28. The brake pads 18 extend substantially parallel to the inner contact surfaces 26 and/or the brake disc portions 20. The brake pads 18 each comprise a brake lining 19 formed by a friction material at a face thereof facing the respectively adjacent inner contact surface 26. More precisely, the brake lining 19 of the left brake pad 18 in FIG. 1 is directly adjacent and opposite to the left inner contact surface 26, whereas the brake lining 19 of the right brake pad in FIG. 1 is directly adjacent and opposite to the right inner contact surface 26.

The brake pads 18 are arranged at opposite sides of a housing 34 of the braking unit 16. The housing 34 may form or be formed by a brake caliper. Specifically, the brake pads 18 are arranged so that their brake linings 19 face away from one another and face a respectively adjacent inner contact surface 26. Also, the brake pads 18 are axially spaced apart from one another when viewed along the rotational axis R.

FIG. 1 shows a non-activated state of the brake assembly 10. Therefore, a small gap remains between the brake linings 19 and each contact surfaces 26 to prevent drag torque. When activated, the brake pads 18 move axially apart from one another as indicated by arrows in FIG. 1. An axial distance between the brake pads 18 is thus increased and each brake lining 19 is brought into contact with the respectively opposite inner contact surface 26. This generates frictional forces between the brake linings 19 and inner contact surfaces 26 which brake a rotation of the braked member 14.

In the shown example, the braking unit 16 and specifically its housing 34 comprises a hydraulic chamber 36. The hydraulic chamber 36 is part of or resembles the brake force generator 12.

According to a generally known configurations, a hydraulic pressure can be built up in said hydraulic chamber 36 for moving the brake pads 18, thus activating the brake. In more detail, each brake pad 18 is connected to a piston 38 that is slidingly received in the housing 34 and reaches into the hydraulic chamber 34. By increasing the pressure inside the hydraulic chamber 34, the pistons 38 are axially moved apart from one another and pushed outward. When releasing the pressure in the hydraulic chamber, the pistons 38 and thus the brake pads 18 can retract, so that the brake linings 19 are lifted off and away from the respectively opposite inner contact surfaces 26. This retraction movement may be supported by known elastic seals which act on the pistons 38.

It is to be noted that the pistons 38 as well as at least part of the hydraulic chamber 36 as well as part of the housing 34 are received within the space 28.

Further, any of these members as well as the brake pads 18 (and generally the braking unit 16 as a whole) may have a defined extension in the circumferential direction and/or orthogonally to the image plane so that a sufficiently large areal contact between the brake pads and the inner contact surfaces 26 is formed. Preferably, this circumferential extension is limited to below of 180° or below of 135° to increase compactness and save weight.

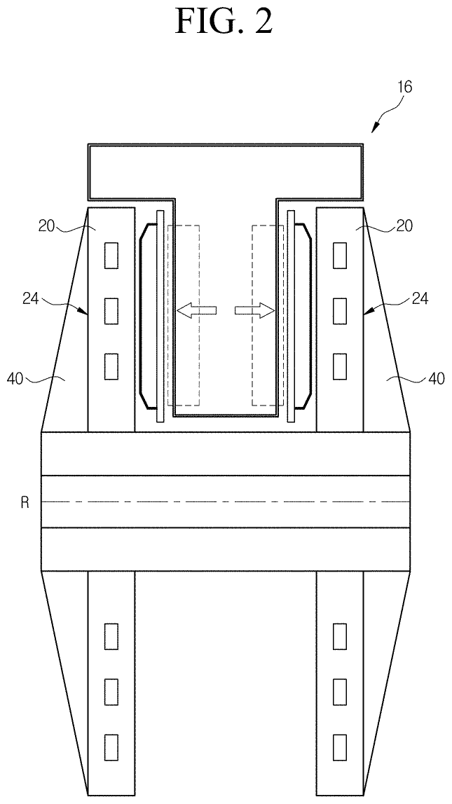

FIG. 2 shows a brake assembly 10 according to a second embodiment. The only difference to the first embodiment are stiffening structures 40 that are provided at the outer contact surfaces 24 of each brake disc portion 20. The stiffening structures 40 are formed as radially extending ribs. They may be distributed circumferentially, e.g. in a star-like manner, to support the brake disc portions 20 against bending.

Compared to FIG. 2, the connecting portion 22 is axially elongated to support the stiffening structures 40 at its outer circumferential surface. In one example, the stiffening structures 40 and connecting portion 22 from a one-piece member. Additionally or alternatively, the stiffening structures 40 may be an integral part of the brake disc portions 20.

FIG. 3 shows a brake assembly 10 according to a third embodiment. In this case, the outer contact surfaces 24 of the brake disc portions 20 are each contacted by a brake pad 18 as well to generate additional brake forces. Accordingly, the braking unit 16 also comprises two outer brake pads 18 each being adjacent to one of the outer contact surfaces 24. In the shown example, these brake pads 18 are configured similarly to the inner brake pads 18 that are arranged in the circumferential space 28 of the braked member 14.

The housing 34 of the brake unit 16 has axially outer portions 35 that face the outer contact surfaces 24. The axially outer portions 35 are axially positioned further outwards compared to the outer contact surfaces 24. Each axially outer portion 35 receives a piston 38 so that a brake pad 18 arranged at the respective axially outer portion 35 can be displaced in a similar manner as described above with respect to the first embodiment. For doing so, the hydraulic chamber 36 also extends into the axially outer portions 35. The inner brake pads 18 are generally configured and displaced similar to the first embodiment.

In order to generate brake forces, a hydraulic pressure within the hydraulic chamber 36 is built up, upon which all four brake pads 18 are displaced simultaneously towards their respectively opposite inner or outer contact surface 24, 26. Thus, one single brake force generator 12 comprising said hydraulic chamber 36 suffices to activate the braking function.

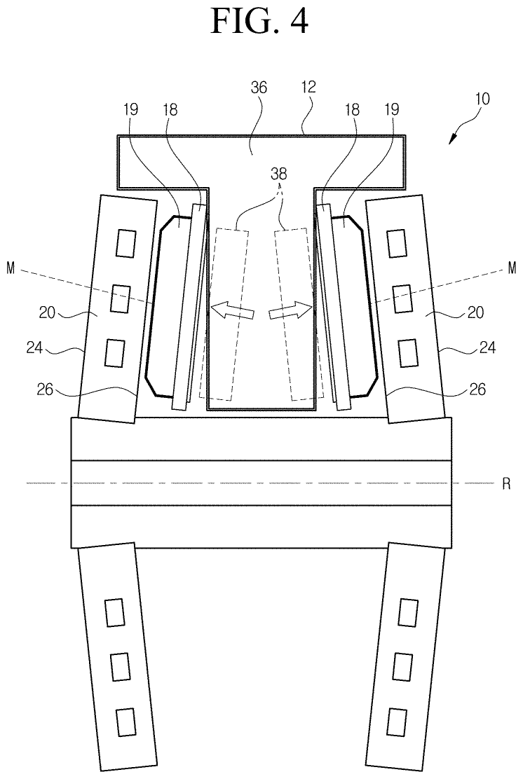

FIG. 4 depicts a brake assembly 10 according to a fourth embodiment. In this example, the brake pads 18 and inner contact surfaces 26 do not extend orthogonally to the rotational axis R, but are tilted at a different angle thereto (i.e., are inclined with respect to the rotational axis R). Preferably, however, the brake pads 18 still extend in parallel to their respectively opposite contact surface 26.

Each brake pad 18 moves along an individual movement axis M. The movement axes M preferably intersect a respective brake lining 19 and/or the opposite contact surface 26 orthogonally. The movement axes M extend at an angle relative to one another as well as to the rotational axis R. The movement axes M thus define a V-shape that, in the shown example, opens to the radial outside.

The contact surfaces 26 (and preferably the complete brake disc portions 20 at which they are provided) are equally tilted relative to the rotational axis R, i.e. do not extend orthogonally thereto. Preferably, the contact surfaces 26 are tilted (axially) inwardly and/or towards each other. This limits bending to the axial outside when the brake pads 18 are pushed against them.

Other than that, the brake assembly 10 and in particular the brake force generator 12 operates similar to the first and second embodiment. Even though this is not depicted, further brake pads 18 acting on the outer contact surfaces 24 as in the third embodiment could equally be provided in case of FIG. 4.

What is claimed is:

1. A brake assembly for a vehicle wheel, the brake assembly comprising:
a braked member that is coupable or coupled to the vehicle wheel for a joint rotation therewith about a rotational axis, the braked member having contact surfaces that are arranged at an axial distance from one another; and
a braking unit that comprises a brake force generator and at least two brake pads, the brake pads being positioned in between the contact surfaces,
wherein the brake force generator is configured move the brake pads axially apart from one another, thereby bringing each brake pad into contact with one of the contact surfaces of the braked member.

2. The brake assembly according to claim 1,
wherein the contact surfaces face each other.

3. The brake assembly according to claim 1,
wherein the contact surfaces form at least part of opposite side faces of a space in which the brake pads are at least partially received.

4. The brake assembly according to claim 3,
wherein a brake dust collector is arranged within said space, in particular at a bottom face that extends in between the contact surfaces.

5. The brake assembly according to claim 1,
wherein the brake pads are movable apart from one another along an axis extending in parallel to the rotational axis (R).

6. The brake assembly according to claim 1,
wherein the contact surfaces are each comprised by brake disc portions of the braked member.

7. The brake assembly according to claim 6,
wherein the brake disc portions extend in parallel to one another, in particular wherein the brake disc portions each extend orthogonally to the rotational axis (R) of the braked member.

8. The brake assembly according to claim 1,
wherein at least one of the brake disc portions comprises a stiffening structure at a side thereof that is opposite to the side comprising the contact surface of the at least one brake disc portion.

9. The brake assembly according to claim 1,
wherein each of the brake pads is displaceable relative to a housing of the braking unit and relative to one another.

10. The brake assembly according to claim 1,
wherein the brake force generator comprises one of an electric actuator and a hydraulic chamber, each of which being configured to generate the force for moving both of the brake pads.

11. The brake assembly according to claim 10,
wherein at least part of the electric actuator or hydraulic chamber are received in the space.

12. The brake assembly according to claim 1,
comprising at least one further brake pad that can be brought into contact with a further contact surface facing away from at least one of the other contact surfaces.

13. A method of operating a brake pad assembly, the brake pad assembly comprising:
a braked member that is coupable or coupled to the vehicle wheel for a joint rotation therewith about a rotational axis (R), the braked member having contact surfaces that are arranged at an axial distance from one another; and
a braking unit that comprises at least two brake pads, the brake pads being positioned in between the contact surfaces,
wherein the method comprises: moving the brake pads axially apart from one another, thereby bringing each brake pad into contact with one of the contact surfaces of the braked member.
